(19) United States
(12) Patent Application Publication
(10) Pub. No.: US 2009/0027427 A1
(43) Pub. Date: Jan. 29, 2009

(54) DRIVE CIRCUIT FOR LIQUID CRYSTAL DISPLAY DEVICE AND LIQUID CRYSTAL DISPLAY DEVICE HAVING THE SAME

(76) Inventor: Seiichi Takasuka, Kawasaki (JP)

Correspondence Address: CONNOLLY BOVE LODGE & HUTZ, LLP, P O BOX 2207, WILMINGTON, DE, 19899, US

(21) Appl. No.: 11/872,608

(22) Filed: Oct. 15, 2007

(30) Foreign Application Priority Data
Oct. 16, 2006 (JP) 2006-281125

(51) Int. Cl. G09G 5/02

(52) U.S. Cl. 345/698

(57) ABSTRACT

The present disclosure provides a drive circuit for a liquid crystal display device, including: a main reference table, having an entry for a drive voltage applied to a pixel at a border of a partitioned area; a sub reference table, having an entry for a drive voltage applied to a pixel in the partitioned area; and an area determining circuit element, for determining the partitioned area for a pixel according to a value of an input image signal for the pixel and determining whether the drive voltage is obtained by using the main reference table or by using the sub reference table, according to the partitioned area determined. Therefore, an appropriate over drive voltage may be obtained and the number of the entries may be lowed.

### CLAIM OF PRIORITY

This application claims the benefit of priority under 35 U.S.C. § 119 of Japanese application serial no. 2006-281125, filed Oct. 16, 2006 which is incorporated herein by reference in its entirety.

### TECHNICAL FIELD

The present invention relates to the field of display techniques, and in particular to a drive circuit for a liquid crystal display device and a liquid crystal display device having the same.

### BACKGROUND

Compared with a display device using CRT (cathode ray tube), a liquid crystal display device has prominent advantages in the thin thickness and the low power consuming.

However, the picture response speed of the liquid crystal is lower than that of the CRT because the picture response speed of the liquid crystal depends on the starting speed of the liquid crystal molecule based on the applied electric field.

In order to improve the response speed for the liquid crystal display device, an over drive method is disclosed in a Japanese patent application (No. H07-020828) filed on Jan. 24, 1995, incorporated herein by reference. In the over drive method, instead of the voltage calculated from the image data, a voltage higher than the voltage calculated from image data (hereinafter, referred as an over drive voltage) is applied to a pixel electrode according to a difference between the image data of current frame and the image data of previous frame. Thus, the response speed is improved. In practice, the over drive voltage depends on a combination of the image data of the current frame and the image data of the previous frame and hence is very complex and cannot be determined through a simple formula. The over drive voltage may be determined according to measured values of combinations of the image data of the current frame and the image data of the previous frame. Therefore, in order to obtain an optimal value, the over drive voltage needs to be determined according to all combinations of the image data of the current frame and the image data of the previous frame, and a reference table is provided with the combinations as entries. In this way, the number of the combinations is very large and is about the square of the number of the image data. When the image data is large, the number of the entries becomes large and the reference table becomes very large. In addition, the reference table is required to have a high speed, thus leading to a high cost.

A previously known method for solving the above problems is as follows. The entries of the reference table are not provided based on all combinations of the image data. Instead, the areas corresponding to all combinations are partitioned into sub-areas with a prescribed number. When establishing the reference table, a minimum drive voltage of pixels in each area to be applied (hereinafter, referred as area minimum drive voltage), and a maximum drive voltage of pixels in each area to be applied (hereinafter, referred as area maximum drive voltage) are used as entries. As for a pixel having a voltage between the area maximum drive voltage and the area minimum drive voltage, the over drive voltage is to be determined with the linear interpolation method using the area maximum drive voltage and the area minimum drive voltage. The over drive voltage can be calculated by linearly interpolating the area maximum drive voltage and the area minimum drive voltage.

However, in the previously known method, since an area with a large difference between the practice optimal value and a corrected value exists, a proper over drive voltage may not be obtained in the area.

### SUMMARY OF THE INVENTION

Therefore, an object of the present disclosure is to provide a drive circuit for a display device, which may reduce the number of the entries in the reference table and obtain an appropriate over drive voltage.

A drive circuit for a liquid crystal display device, including: a main reference table, having entries for drive voltages applied to pixels at a border of a partitioned area; a sub reference table, having entries for drive voltages applied to pixels in the partitioned area; and an area determining circuit element, including: an area partitioning module, for partitioning an area into a plurality of partitioned areas according to a maximum combination of image data values of a previous frame and image data values of a current frame; a determining module for determining the partitioned area for a pixel according to a value of an input image signal for the pixel; and a selecting module for determining whether the drive voltage is obtained by using the main reference table or by using the sub reference table, according to the partitioned area determined.

A drive method for a liquid crystal display device, including: partitioning an area into a plurality of partitioned areas according to a maximum combination of image data values of a previous frame and image data values of a current frame; establishing a main reference table listing corresponding drive voltages applied to pixels located at a border of the partitioned area as entries; establishing a sub reference table for each predetermined portioned area as entries, the sub reference table listing a corresponding drive voltage applied to each pixel in the corresponding partitioned area; determining which partitioned area an objective pixel belongs to according to image data values of the objective pixel in the previous frame and the current frame; if the objective pixel belongs to the portioned area corresponding to the sub reference table, obtaining a drive voltage for the objective pixel according to the corresponding sub reference table; otherwise, obtaining a drive voltage for the objective pixel according to the main reference table.

According to the present disclosure, when performing a driving based on the over drive method, a small reference table with less number of entries may be used and a more accurate over drive voltage may be obtained compared with the prior art. Therefore, a display device, which has a lower cost and a faster response speed, may be fabricated.

### BRIEF DESCRIPTION OF THE DRAWINGS

FIG. 1 is a schematic diagram illustrating a drive circuit for a display device according to one embodiment described herein;

FIG. 2 is a schematic diagram illustrating a relationship between an input image signal and the main reference table, the partitioned area and the sub reference table respectively; and

FIG. 3 is a schematic diagram illustrating the content of the sub reference table.

### DETAILED DESCRIPTION OF THE EMBODIMENTS

Hereinafter, detailed descriptions on certain embodiments will be provided with reference to the drawings.

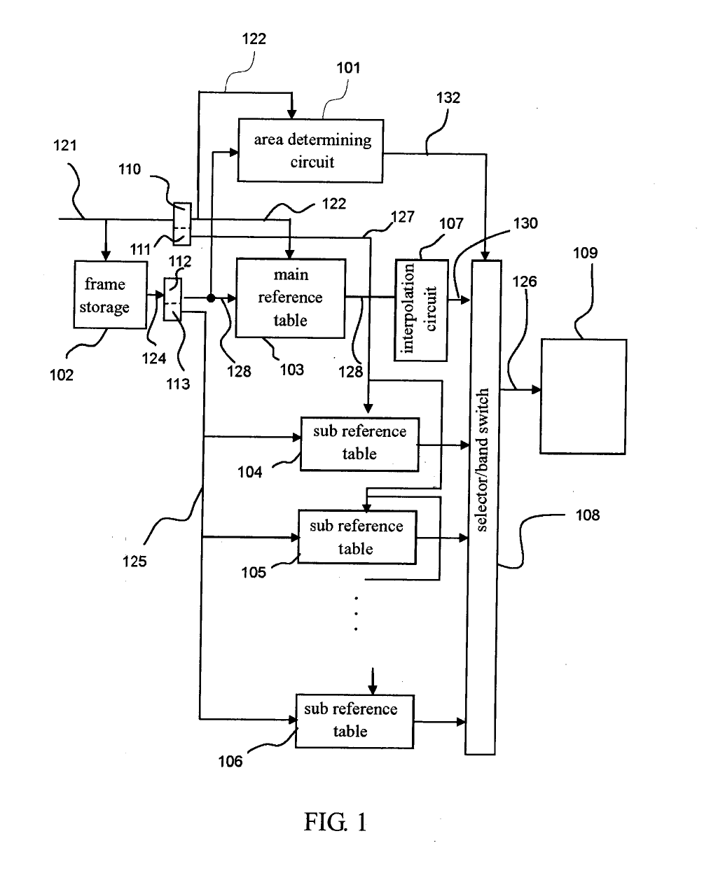

FIG. 1 is a schematic diagram illustrating a drive circuit for a display device according to one embodiment of the present invention.

In FIG. 1, reference numeral 101 represents the area determining circuit element, reference numeral 102 represents a frame storage for temporarily storing an input image signal of the previous frame, reference numeral 121 represents an 8-bits input image signal of the current frame, reference numeral 110 represents high-order four bits of the input image signal of the current frame 121, reference numeral 111 represents low-order four bits of the input image signal of the current frame 121, reference numeral 124 represents an 8-bits input image signal of the previous frame, reference numeral 112 represents high-order four bits of the 8-bits input image signal of the previous frame, reference numeral 113 represents low-order four bits of the 8-bits input image signal of the previous frame, reference numeral 103 represents a main reference table, reference numerals 104-106 represent the sub reference tables, reference numeral 108 represents a selector, reference numeral 109 represents a pixel unit, reference numeral 122 represents high-order four bits of the 8-bits input image signal of the current frame, reference numeral 127 represents low-order four bits of the 8-bits input image signal of the current frame, reference numeral 128 represents high-order four bits of the 8-bits input image signal of the previous frame, reference numeral 125 represents low-order four bits of the 8-bits input image signal of the previous frame, and reference numeral 126 represents the drive voltage applied to the pixel electrode. Wherein, 110 and 122, 111 and 127, 112 and 128, 113 and 125 are respectively the same, or substantially the same.

In the drive circuit for the display device according to the embodiment of the present invention, the input image signal 121 is an 8-bits signal and high-order four bits of the 8-bits input image signal is used to divide the whole area to partitioned areas. In addition, the high-order four bits of the 8-bits input image signal is used to determine the drive voltage according to the main reference table 103. In addition, according to low-order four bits of the 8-bits input image signal, the area determining circuit element 101 determines whether the interpolation circuit 107 or the sub reference table 104 is selected to obtain the drive voltage.

Additionally, the sub reference table 104 corresponds to the low-order four bits of the 8-bits input image signal.

The main reference table 103 and the sub reference table 104 assigns the input image signal of the previous frame to the vertical axis and assigns the input image signal of the current frame to the horizontal axis.

The main reference table 103 sets the drive voltage to be applied to the pixels at the border of the partitioned areas as an entry.

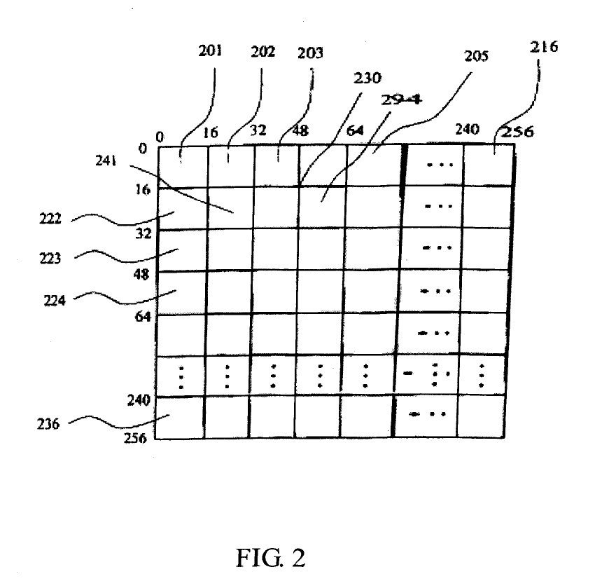

FIG. 2 is a schematic diagram illustrating a relationship between the input image signal and the main reference table, the partitioned area and the sub reference table respectively.

The vertical axis of FIG. 2 represents the input image signal of the previous frame and the horizontal axis of FIG. 2 represents the input image signal of the current frame. The value of the input image signal is up to 256 because the input image signal has eight bits.

In FIG. 2, reference numeral 201 represents a partitioned area including pixels in which the value of the input image signal of the previous frame ranges from 0 to 15 and the value of the input image signal of the current frame ranges from 0 to 15, reference numeral 202 represents a partitioned area including pixels in which the value of the input image signal of the previous frame ranges from 0 to 15 and the value of the input image signal of the current frame ranges from 16 to 31, reference numeral 203 represents a partitioned area including pixels in which the value of the input image signal of the previous frame ranges from 0 to 15 and the value of the input image signal of the current frame ranges from 32 to 47, reference numeral 216 represents a partitioned area including pixels in which the value of the input image signal of the previous frame ranges from 0 to 15 and the value of the input image signal of the current frame ranges from 240 to 255, reference numeral 222 represents a partitioned area including pixels in which the value of the input image signal of the previous frame ranges from 16 to 31 and the value of the input image signal of the current frame ranges from 0 to 15, reference numeral 223 represents a partitioned area including pixels in which the value of the input image signal of the previous frame ranges from 32 to 47 and the value of the input image signal of the current frame ranges from 0 to 15, reference numeral 224 represents a partitioned area including pixels in which the value of the input image signal of the previous frame ranges from 48 to 63 and the value of the input image signal of the current frame ranges from 0 to 15, reference numeral 236 represents a partitioned area including pixels in which the value of the input image signal of the previous frame ranges from 240 to 255 and the value of the input image signal of the current frame ranges from 0 to 15, and reference numeral 230 represents an intersection point of a horizontal axis with the value of the input image signal of the previous frame being 16 and a vertical axis with the value of the input image signal of the current frame being 48.

As for a pixel satisfying the value of the input image signal for an intersection point of a horizontal axis and a vertical axis, a drive voltage to be applied to the pixel is used as an entry of the main reference table 103. Taking the intersection point 230 as an example, the voltage to be applied to the intersection point 230 is the voltage to be applied to the pixel whose input image signal value of the previous frame is 16 and that of the current frame is 48.

For each pixel, according to the value of the input image signal of the previous frame and the value of the input image signal of the current frame, the area determining circuit element 101 determines which partitioned area in FIG. 2 the pixel belongs to. Then, the area determining circuit element 101 determines whether the drive voltage is obtained by using the main reference table or by using the sub reference table, based on the partitioned area determined.

For example, if the pixel belongs to a partitioned area 205, the drive voltage is obtained using the sub reference table. The area determining circuit element 101 determines the drive voltage for the pixel while determining that the pixel belongs to the partitioned area 205. Then, the area determining circuit element 101 selects a sub reference table corresponding to the partitioned area 205 and obtains the drive voltage using the sub reference table selected according to the low-order four bits of the input image signal of the current frame and the input image signal of the previous frame.

Then, the selector 108 shown in FIG. 1 selects the drive voltage and outputs it to the pixel electrode 109.

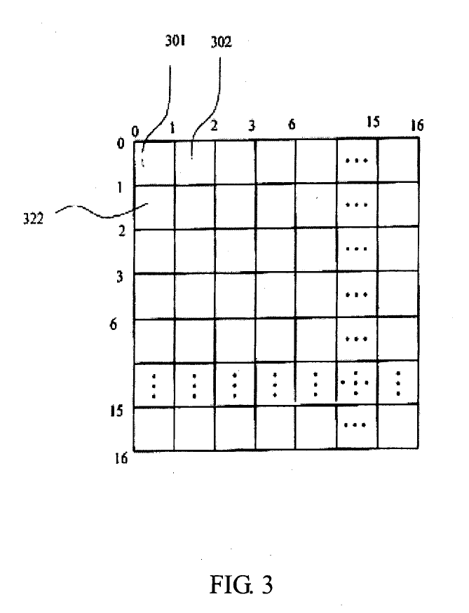

FIG. 3 is a schematic diagram illustrating the content of the sub reference table. The sub reference table is referred by the low-order four bits of the input image signal. The sub reference table is a table with 16 rows and 16 columns.

In FIG. 3, reference numeral 301 represents a drive voltage to be applied to a pixel with the low-order four bits of the input image signal of the previous frame being 0000 and the low-order four bits of the input image signal of the current frame being 0000, reference numeral 302 represents a drive voltage to be applied to a pixel with the low-order four bits of the input image signal of the previous frame being 0000 and the low-order four bits of the input image signal of the current frame being 0001, and reference numeral 322 represents a drive voltage to be applied to a pixel with the low-order four bits of the input image signal of the previous frame being 0001 and the low-order four bits of the input image signal of the current frame being 0000.

Because the sub reference table is referred by the low-order four bits of the input image signal, the pixel location in the sub reference table is a relative position and corresponds to a partitioned area.

For example, if the sub reference table is used for pixels in the partitioned area 241 in FIG. 2, the relative positions of all areas in the sub reference table selected according to pixels in partitioned area 241 correspond to the position where high-order four bits of the input image signal in the previous frame are 0001 and high-order four bits of the input image signal in the current frame are 0001.

On the other hand, when it is determined that the linear interpolation method is used to obtain the drive voltage, based on the main reference table, a coordinate difference is calculated according to the pixel coordinate of the border of the partitioned area and a corresponding pixel coordinate. After a drive voltage to be applied to pixels of the border of the partitioned area is obtained from the main reference table, the drive voltage 130 to be applied to the corresponding pixel is obtained according to the coordinate difference and the drive voltage to be applied to pixels of the border of the partitioned area. Wherein, the pixel coordinate is determined based on previous frame image data value and the current frame image data value of the pixel, and the pixel coordinate of the border pixels is determined based on the previous frame image data value and the current frame image data value of the border pixels.

Hence, the drive voltage 130 is selected by the selector 108 shown in FIG. 1 and is applied to the pixel electrode. Furthermore, there are four pixels at the border and there should be four drive voltages to be applied to the four pixels respectively. A coordinate system is constructed with the input image signal of the previous frame as the vertical axis and with the input image signal of the current frame as the horizontal axis. A difference operation is performed to the horizontal axis and the vertical axis to obtain the difference respectively. The drive voltage may be obtained by performing the linear interpolation operation to the differences.

Taking the partitioned area 294 as an example, the partitioned area 294 is a partitioned area including pixels in which the value of the input image signal of the previous frame ranges from 16 to 31 and the value of the input image signal of the current frame ranges from 48 to 63. When it is determined that the linear interpolation operation may be used for the pixels in the partitioned area 294 by the area determining circuit element 101, the border includes four pixels, that is, pixels whose value of the input image signal of the current frame is 48 or 64 and whose value of the input image signal of the previous frame is 16 or 32, and based on coordinates of the four pixels and four drive voltages to be applied to the four pixels in the main reference table, the drive voltage to be applied to the pixel as an object is obtained by using the linear interpolation method at the vertical axis and the horizontal axis. In addition, the linear interpolation method and its application are known to those of ordinary skill in the art and, accordingly, descriptions thereof are omitted herein.

The area determining circuit element 101 selects the above drive voltage via the selector 108. As a result, the drive voltage is applied to the pixel electrode 109.

Compared with the drive circuit which determines the drive voltage by using the reference table for all pixels, the total size of the main reference table and the sub reference table is significantly reduced in the drive circuit for the liquid crystal display device according to the embodiment of the present invention. Because the element constructing the reference table requires a high speed, the cost of the reference table is high. Therefore, the drive circuit for the liquid crystal display device according to the embodiment of the present invention may reduce the cost. On the other hand, compared with the solution which decreases the number of the entries in the main reference table and uses the linear interpolation method, the sub reference table is assigned for the partitioned areas which may not obtain an appropriate drive voltage based on the linear interpolation method in the drive circuit according to an embodiment of the present invention. Therefore, a more appropriate drive voltage may be obtained and the picture quality may be improved.

Moreover, for each partitioned area, whether the drive voltage is determined based on the main reference table or based on the sub reference table, depends on combinations of the input image signal of the previous frame and the input image signal of the current frame. In practice, the drive voltage is determined by applying each drive voltage to the pixel electrode and checking the over drive effect. In addition, for the drive voltage in the sub reference table, the drive voltage is also obtained by using the combinations of the input image signal of the previous frame and the input image signal of the current frame, applying each drive voltage to the pixel electrode and checking the over drive effect.

Moreover, each of the main reference table, the sub reference table, the linear interpolation circuit, the selector and the frame storage may be fabricated with a well known semiconductor device and circuit, and descriptions thereof are omitted.

Moreover, the present disclosure characterizes in that, for the areas determined by combinations of the input image signal of the previous frame and the input image signal of the current frame, the drive voltage is obtained by only using the reference table for the areas which may not obtain an appropriate drive voltage, while not using an empirical drive voltage as an entry of the reference table for all areas. As previously referenced herein, the linear interpolation method used in the present disclosure is well known in the art and descriptions thereof are omitted.

What is claimed is:

1. A drive circuit for a liquid crystal display device, comprising:
a main reference table, having entries for drive voltages applied to pixels at a border of a partitioned area;
a sub reference table, having entries for drive voltages applied to pixels in the partitioned area; and
an area determining circuit element, comprising:
an area partitioning module, for partitioning an area into a plurality of partitioned areas according to a maximum combination of image data values of a previous frame and image data values of a current frame;
a determining module for determining the partitioned area for a pixel according to a value of an input image signal for the pixel; and
a selecting module for determining whether the drive voltage is obtained by using the main reference table or by using the sub reference table, according to the partitioned area determined.

2. The drive circuit according to claim 1, wherein:
in the partitioned area determined by the area determining circuit element, when the selecting module determines that the drive voltage is to be obtained by using the main reference table, the drive voltage to be applied to the pixel is obtained according to the drive voltages for pixels at the border of the partitioned area and a difference between a pixel coordinate and a border coordinate; and
when the selecting module determines that the drive voltage is to be obtained by using the sub reference table, the drive voltage corresponding to the pixel is obtained according to the sub reference table corresponding to the partitioned area determined.

3. The drive circuit according to claim 1, wherein, if the value of the input image signal is an N-bits binary number:
the partitioned area is established according to high-order M bits of the N-bits binary number; and
the sub reference table is established according to low-order (N−M) bits of the N-bits binary number, wherein, M<N.

4. The drive circuit according to claim 1, wherein, N=8 and M=4.

5. A liquid crystal display device, comprising the drive circuit according to claim 1.

6. A drive method for a liquid crystal display device, the method comprising:
partitioning an area into a plurality of partitioned areas according to a maximum combination of image data values of a previous frame and image data values of a current frame;
establishing a main reference table listing corresponding drive voltages applied to pixels located at a border of the partitioned area as entries;
establishing a sub reference table for each predetermined portioned area as entries, the sub reference table listing a corresponding drive voltage applied to each pixel in the corresponding partitioned area;
determining which partitioned area an objective pixel belongs to according to image data values of the objective pixel in the previous frame and the current frame; and
if the objective pixel belongs to the portioned area corresponding to the sub reference table, obtaining a drive voltage for the objective pixel according to the corresponding sub reference table; otherwise, obtaining a drive voltage for the objective pixel according to the main reference table.

7. The drive method according to claim 6, wherein the process of obtaining a drive voltage for the objective pixel according to the corresponding sub reference table further comprises:
finding out corresponding drive voltage in the sub reference table according to the image data values of the objective pixel in the previous frame and the current frame; and
selecting the corresponding drive voltage in the sub reference table as the drive voltage for the objective pixel.

8. The drive method according to claim 6, wherein the process of obtaining a drive voltage for the objective pixel according to the main reference table further comprises:
calculating a difference between a coordinate of the objective pixel and coordinates of border pixels in corresponding portioned area, and obtaining drive voltages of the border pixels in the corresponding portioned area; and
obtaining the drive voltage for the objective pixel by linear interpolation method according to the difference and the drive voltages of the border pixels.

9. The drive method according to claim 6, wherein, the process of partitioning the area into a plurality of partitioned areas according to the maximum combination of image data values of the previous frame and image data values of the current frame comprises:
if the image data value is N-bits binary number,
establishing partitioned areas based on the high-order M bits of the N bits of the image data; and
establishing the sub reference table based on the low-order (N−M) bits of the N bits of the image data, wherein, M<N.

10. The drive method according to claim 6, wherein N=8 and M=4.
